(19) United States
(12) Patent Application Publication
(10) Pub. No.: US 2008/0137491 A1
(43) Pub. Date: Jun. 12, 2008

(54) Optical disk drive with defocus-prohibited device

(75) Inventors: Shih-Lin Yeh, Hsinchu (TW); Jung-Fu Chen, Hsinchu (TW); Chih-Ming Yang, Hsinchu (TW); Yung-Han Wu, Hsinchu (TW); Shih-Ming Hsu, Hsinchu (TW)

Correspondence Address: BIRCH STEWART KOLASCH & BIRCH, PO BOX 747, FALLS CHURCH, VA, 22040-0747, US

(73) Assignee: LITE-ON IT CORP.

(21) Appl. No.: 11/820,000

(22) Filed: Jun. 29, 2007

(30) Foreign Application Priority Data
Dec. 8, 2006 (TW) 95146046

(51) Int. Cl. G11B 7/00

(52) U.S. Cl. 369/44.14

(57) ABSTRACT

An optical disk drive with a defocus-prohibited device comprising: a frame; a cover disposed on the frame; a disk-rotating device disposed at an end of the frame; two guiding rods disposed at sides of the frame respectively and elongated from the end with the disk-rotating device to another end of the frame; a pick-up head capable of moving back and forth on the two guiding rods, and reading an optical disk driven by the disk-rotating device; and at least one flexible member being disposed between the pick-up head and the cover for providing a force on the pick-up head in advance.

### BACKGROUND OF THE INVENTION

1. Field of the Invention

The present invention generally relates to an optical disk drive with a defocus-prohibited device, more particularly to an optical disk drive adopting the way of directly pressing a force or applying a prestressing force on a pick-up head.

2. Description of the Prior Art

With the development to the specifications of optical disks, the storage capacities of the optical disks are getting more. On the other hand, the optical disk drive for reading and writing data on said optical disks may need higher reading and writing accuracy. In prior arts, due to the mechanism in the optical disk drive, a condition of little defocus was happening sometimes, but there is only a little influence for reading and writing data, and the influence can be neglected. Nowadays, the request for higher accuracy makes the little defocus in prior arts be more important than ever, especially in the optical disk drive with the function of light-scribe. That is, if the pick-up head of the optical disk drive is happening the condition of defocus while the optical disk drive uses light-scribe function to burn figure on the label surface of optical disk, there is a darker or lighter circle on the burned pictures so as to decrease the quality of burned figure.

With reference to FIG. 1, a schematic view of causing a defocus condition in prior arts is illustrated. As shown in FIG. 1, a pick-up head A moves along the directions D for reading/writing data on an optical disk (not shown in FIG. 1), and the pick-up head A is electrically connected to a flexible printed circuit (FPC) B so as to transmit data. When the pick-up head A gradually moves toward left, a lift force F1 is applied to the pick-up head A caused by two factors of the curvature change of the flexible printed circuit B and the flexibility of the flexible printed circuit B. Hence, the pick-up head A is lifted up by the lift force F1, and the distance between the pick-up head A and the optical disk (not shown in FIG. 1) is decreased which causes that the pick-up head A burns the optical disk in the conditions of a closer distance and more laser power. As a result, the condition of defocus is happening. Such that, the quality and accuracy for reading and writing are definitely decreased. Further, the quality of burning a logo or figure on the label surface of the optical disk by way of light-scribe may be worse as well.

For a slim optical disk drive, its volume is smaller than others, which mains that it inner room is smaller. Therefore the layout for the mechanisms and components inside the slim optical disk drive is limited. Thus, how to develop a new device for solving the condition of defocus in the limited room is the disclosure provided by the present invention.

### SUMMARY OF THE INVENTION

The primary objective of the present invention is to provide an optical disk drive with a defocus-prohibited device for solving the problem of defocus caused by the design and mechanism layout in prior art.

The secondary objective of the present invention is to provide the optical disk drive with the defocus-prohibited device for saving the cost of solving the problem of defocus.

Preferably, the optical disk drive with the defocus-prohibited device comprising: a frame; a cover disposed on the frame; a disk-rotating device disposed at an end of the frame; two guiding rods disposed at sides of the frame respectively and elongated from the end with the disk-rotating device to another end of the frame; a pick-up head capable of moving back and forth on the two guiding rods, and reading an optical disk driven by the disk-rotating device; and at least one flexible member disposed between the pick-up head and the cover; wherein the cover presses the flexible member, and an elastic force from the flexible member is applied to the pick-up head.

Preferably, the optical disk drive with the defocus-prohibited device comprising: a frame; a cover disposed on the frame; a disk-rotating device disposed at an end of the frame; two guiding rods disposed at sides of the frame respectively and elongated from the end with the disk-rotating device to another end of the frame; a pick-up head capable of moving back and forth on the two guiding rods, and reading an optical disk driven by the disk-rotating device; and at least one flexible member disposed on a surface of the pick-up head and capable of pressing the guiding rod so as to apply a prestressing force on the pick-up head.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic view of causing a defocus condition in prior arts;

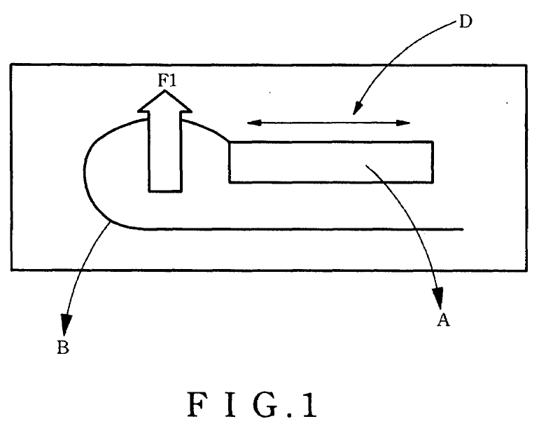

FIG. 2 illustrates a schematic partial 3-D exploded view of a first preferred embodiment of the present invention;

FIG. 3 illustrates a schematic 3-D assembled and enlarged view of the first preferred embodiment of the present invention;

FIG. 4 illustrates a schematic partial 3-D exploded view of a second preferred embodiment of the present invention;

FIG. 5 illustrates a schematic 3-D assembled and enlarged view of the second preferred embodiment of the present invention;

FIG. 6 illustrates a schematic partial 3-D bottom view of a third preferred embodiment of the present invention;

FIG. 7 illustrates a schematic 3-D exploded bottom view of the third preferred embodiment of the present invention;

FIG. 8 illustrates a detail bottom view of applying a prestressing force of the third preferred embodiment of the present invention;

FIG. 9 illustrates a schematic partial 3-D view of a fourth preferred embodiment of the present invention; and

FIG. 10 illustrates a schematic partial 3-D enlarged view of the fourth preferred embodiment of the present invention.

### DETAILED DESCRIPTION OF THE INVENTION

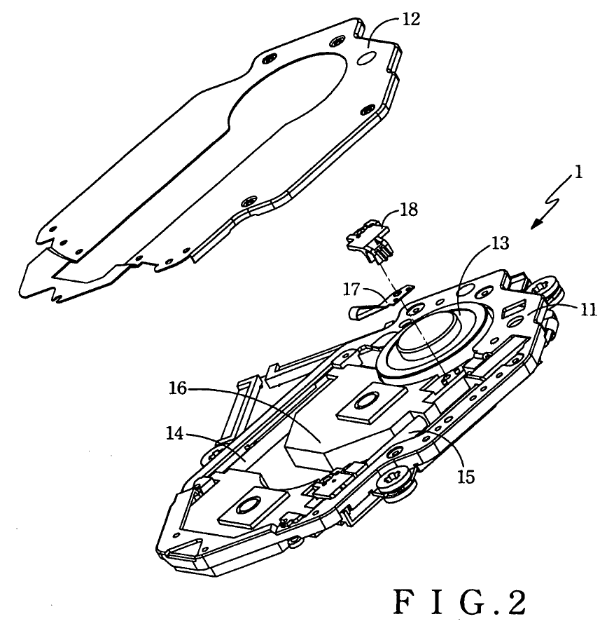

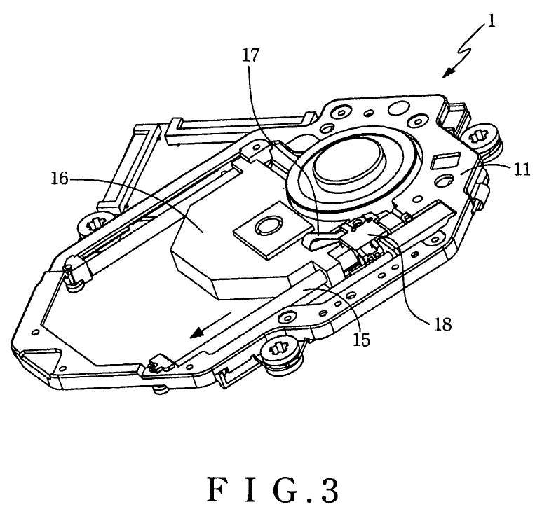

With reference to FIG. 2 and FIG. 3, a schematic partial 3-D exploded view of a first preferred embodiment of the present invention and a schematic 3-D assembled and enlarged view of the first preferred embodiment of the present invention are illustrated. The first preferred embodiment discloses the optical disk drive 1 with a defocus-prohibited device includes: a frame 11; a cover 12, which is disposed on the frame 11; a disk-rotating device 13, which is firmly disposed at an end of the frame 11; two guiding rods 14 and 15, which are firmly disposed at sides of the frame 11 respectively and elongated from the end with the disk-rotating device 13 to another end of the frame 11; a pick-up head 16, which is capable of moving back and forth on the two guiding rods 14 and 15, and reads an optical disk (not shown in figures) driven by the disk-rotating device 16, and writes data; and one flexible member 17, which is disposed on the surface of the pick-up head 16 between the pick-up head 16 and the cover 12 by a fastener 18; wherein the flexible member 17 can be made of mylar material.

When the pick-up head 16 moves along the arrow direction in FIG. 3, the flexible member 17 suppresses a lift force generated by two factors of the curvature change of a flexible printed circuit (not shown in figures) and the flexibility of the flexible printed circuit for prohibiting the pick-up head 16 from being lifted up.

For the preferred embodiment, while assembling the cover 12 to the frame 11, the cover 12 presses and deforms the flexible member 17 to generate an elastic force, which presses the pick-up head 16 down in advance so as to resist the lift force. Besides, due to that of the flexible member 17 being disposed on the pick-up head 16, the flexible member 17 remains the elastic force applied to the pick-up head 16 in order to keep a stable distance between the pick-up head 16 and the optical disk. Hence, the first preferred embodiment can effectively prohibit the condition of the lifting of the pick-up head 16. It is then that the optical disk in burning may not happen the condition of defocus.

The first preferred embodiment adopts the way of direct pressing to prevent that the pick-up head 16 is lifted.

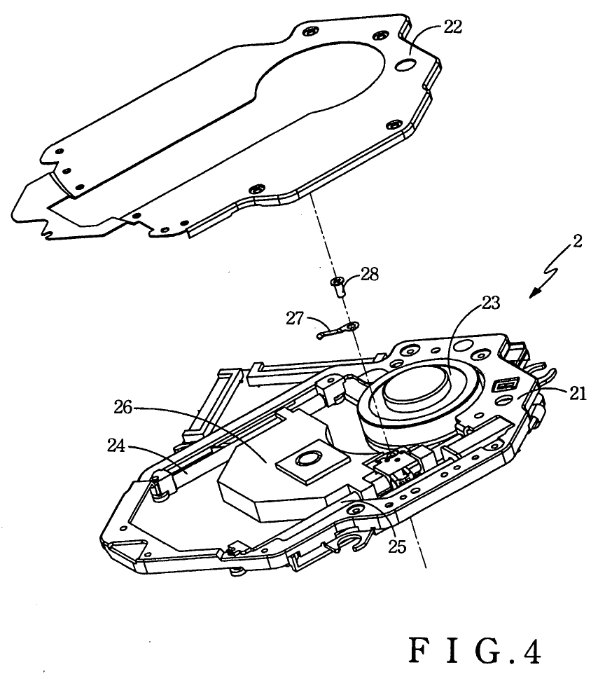

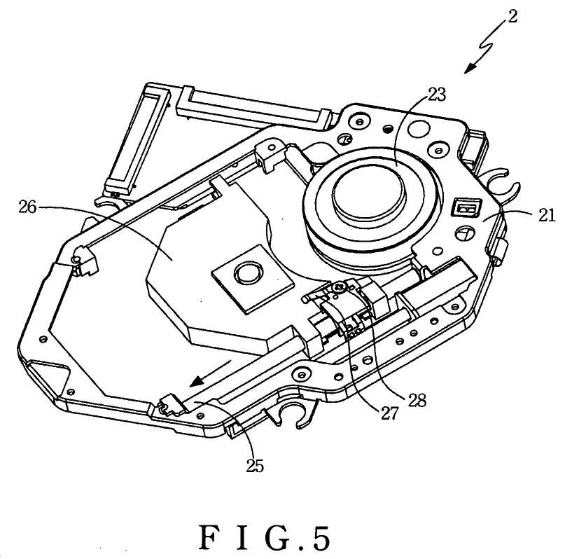

With reference to FIG. 4 and FIG. 5, a schematic partial 3-D exploded view of a second preferred embodiment of the present invention and a schematic 3-D assembled and enlarged view of the second preferred embodiment of the present invention are illustrated. The second preferred embodiment discloses the optical disk drive 2 with a defocus-prohibited device includes: a frame 21; a cover 22, which is disposed on the frame 21; a disk-rotating device 23, which is firmly disposed at an end of the frame 21; two guiding rods 24 and 25, which are firmly disposed at sides of the frame 21 respectively and elongated from the end with the disk-rotating device 23 to another end of the frame 21; a pick-up head 26, which is capable of moving back and forth on the two guiding rods 24 and 25, and reads an optical disk (not shown in figures) driven by the disk-rotating device 26, and writes data; and one flexible member 27, which is disposed on the surface of the pick-up head 26 between the pick-up head 26 and the cover 22 by a fastener 28; wherein the flexible member 27 can be made of metal material.

When the pick-up head 26 moves along the arrow direction in FIG. 5, the flexible member 27 suppresses a lift force generated by two factors of the curvature change of a flexible printed circuit (not shown in figures) and the flexibility of the flexible printed circuit for prohibiting the pick-up head 16 from being lifted up.

For the preferred embodiment, while assembling the cover 22 to the frame 21, the cover 22 presses and deforms the flexible member 27 to generate an elastic force, which presses the pick-up head 26 down in advance so as to resist the lift force. Hence, the second preferred embodiment can effectively prohibit the condition of the lifting of pick-up head 16. It is then that the optical disk in burning may not happen the condition of defocus.

The second preferred embodiment adopts the way of direct pressing to prevent that the pick-up head 26 is lifted.

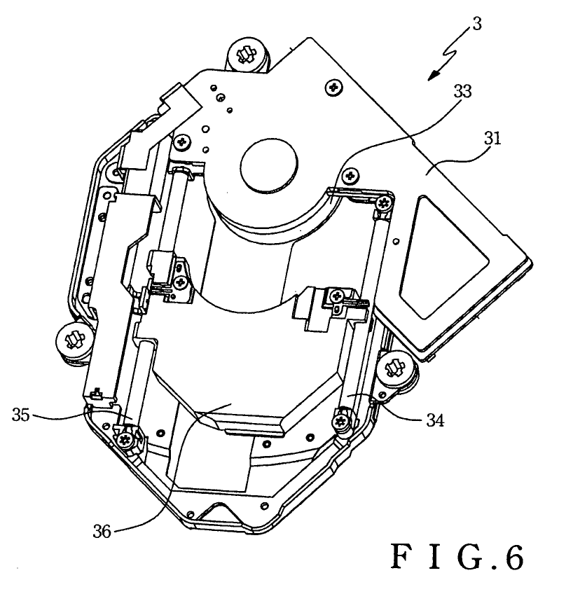

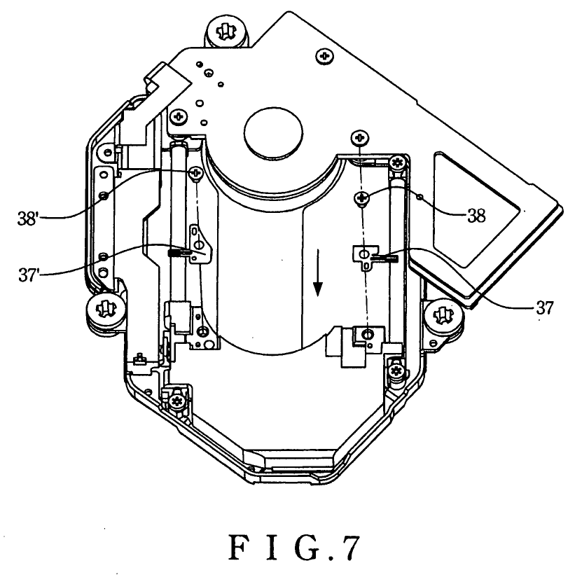

With reference to FIG. 6 and FIG. 7, a schematic partial 3-D bottom view of a third preferred embodiment of the present invention and a schematic 3-D exploded bottom view of the third preferred embodiment of the present invention are illustrated. The third preferred embodiment discloses the optical disk drive 3 with a defocus-prohibited device includes: a frame 31; a cover (not shown in figures), which is disposed on the frame 31; a disk-rotating device 33, which is firmly disposed at an end of the frame 31; two guiding rods 34 and 35, which are firmly disposed at sides of the frame 31 respectively and elongated from the end with the disk-rotating device 33 to another end of the frame 31; a pick-up head 36, which is capable of moving back and forth on the two guiding rods 34 and 35, and reads an optical disk (not shown in figures) driven by the disk-rotating device 33, and writes data; and two flexible members 37 and 37′, which are disposed on opposite sides of a surface of the pick-up head 36 by two fasteners 38 and 38′ and capable of pressing the two guiding rods 34 and 35 so as to apply a downward force on the pick-up head 36; wherein the flexible member 37 and 37′ can be made of metal material.

When the pick-up head 36 moves along the arrow direction in FIG. 7, the flexible member 37 and 37′ provide two prestressing forces to press the pick-up head 36 down, the two prestressing forces are against a lift force generated by two factors of the curvature change of a flexible printed circuit (not shown in figures) and the flexibility of the flexible printed circuit for prohibiting the pick-up head 36 from being lifted up.

Generally speaking, due to that of the pick-up head 36 being pressed down by the two prestressing forces in advance, thus when the pick-up head 36 moves to the outer tracks, the lift force is not power enough to resist the two prestressing forces, the pick-up head 36 may not be lifted up. So that the height of the pick-up head 36 is not changed as always, and the condition of defocus will not happen.

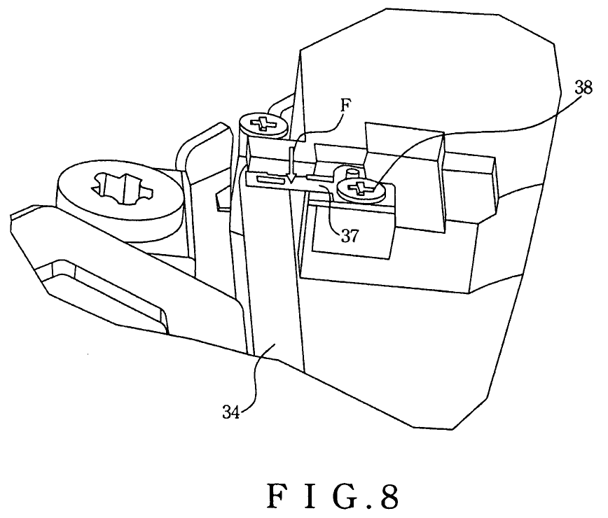

Referring to FIG. 8, which illustrates a detail bottom view of applying a prestressing force of the third preferred embodiment of the present invention. As shown in FIG. 8, an upward prestressing force is applied to the guiding rod 34 after assembling the fastener 38 and the flexible member 37, that is, the pick-up head 36 is pressed down in advance. Further, the third preferred embodiment adopts the way of applying a prestressing force to press the pick-up head 36 down in order to resist the lift force from the flexible printed circuit to lift the pick-up head 36.

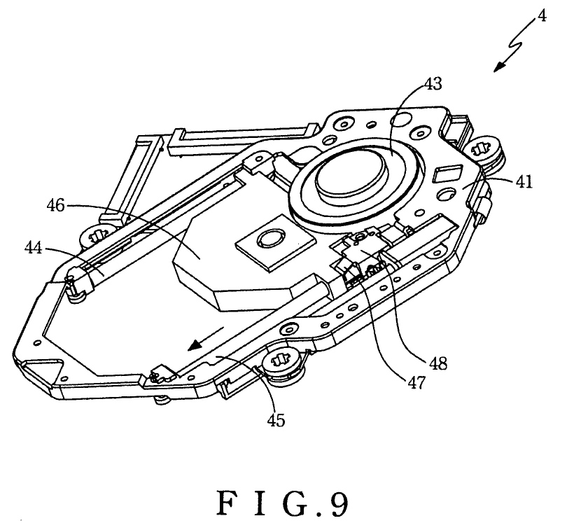

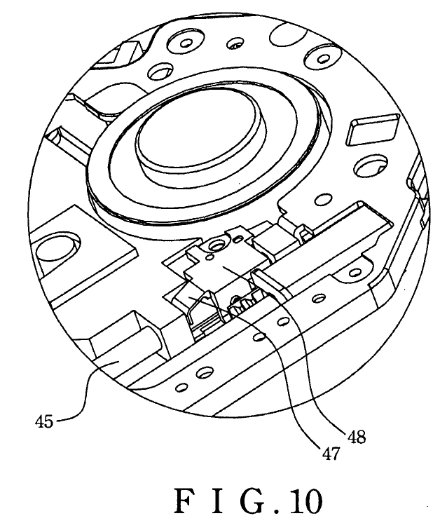

With reference to FIG. 9 and FIG. 10, a schematic partial 3-D view of a fourth preferred embodiment of the present invention and a schematic 3-D partial enlarged view of the fourth preferred embodiment of the present invention are illustrated. The fourth preferred embodiment discloses the optical disk drive 4 with a defocus-prohibited device includes: a frame 41; a cover (not shown in figures), which is disposed on the frame 41; a disk-rotating device 43, which is firmly disposed at an end of the frame 41; two guiding rods 44 and 45, which are firmly disposed at sides of the frame 41 respectively and elongated from the end with the disk-rotating device 43 to another end of the frame 41; a pick-up head 46, which is capable of moving back and forth on the two guiding rods 44 and 45, and reads an optical disk (not shown in figures) driven by the disk-rotating device 43, and writes data; and a flexible member 47, which is disposed on opposite sides of a surface of the pick-up head 46 by a fastener 48 and capable of pressing the guiding rod 45 so as to apply an upward force on the pick-up head 46; wherein the flexible member 47 can be made of metal material.

When the pick-up head 46 moves along the arrow direction in FIG. 9, and the pick-up head 46 is lifted already by the upward force provided by the flexible member 47, therefore there is no space for the pick-up head 46 to be lifted by the curvature change of a flexible printed circuit (not shown in figures) and the flexibility of the flexible printed circuit. That is, the fourth preferred embodiment adopts the way of applying an upward prestressing force to lift the pick-up head 46 up in order to eliminate a room for secondly lifting the pick-up head 46.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An optical disk drive with a defocus-prohibited device comprising:
a frame;
a cover disposed on the frame;
a disk-rotating device disposed at an end of the frame;
two guiding rods disposed at sides of the frame respectively and elongated from the end with the disk-rotating device to another end of the frame;
a pick-up head capable of moving back and forth on the two guiding rods, and reading an optical disk driven by the disk-rotating device; and
at least one flexible member being disposed between the pick-up head and the cover;
wherein the cover presses the flexible member, and an elastic force from the flexible member is applied to the pick-up head.

2. The optical disk drive with a defocus-prohibited device according to claim 1, wherein the flexible member is made by mylar or metal.

3. An optical disk drive with a defocus-prohibited device comprising:
a frame;
a cover disposed on the frame;
a disk-rotating device disposed at an end of the frame;
two guiding rods being disposed at sides of the frame respectively and elongated from the end with the disk-rotating device to another end of the frame;
a pick-up head capable of moving back and forth on the two guiding rods, and reading an optical disk driven by the disk-rotating device; and
at least one flexible member disposed on a surface of the pick-up head and capable of pressing the guiding rod so as to apply a prestressing force on the pick-up head.

4. The optical disk drive with a defocus-prohibited device according to claim 3, wherein the flexible member is a metal piece.

5. An optical disk drive with a defocus-prohibited device comprising:
a frame;
a cover being disposed on the frame;
a disk-rotating device disposed at an end of the frame;
two guiding rods disposed at sides of the frame respectively and elongated from the end with the disk-rotating device to another end of the frame;
a pick-up head capable of moving back and forth on the two guiding rods, and reading an optical disk driven by the disk-rotating device; and
at least one flexible member disposed on a surface of the pick-up head and capable of pressing the guiding rod so as to apply an upward force on the pick-up head.

6. The optical disk drive with a defocus-prohibited device according to claim 5, wherein the flexible member is a metal piece.
